(19) United States
(12) Patent Application Publication
(10) Pub. No.: US 2025/0131607 A1
(43) Pub. Date: Apr. 24, 2025

(54) Smart Key with AR Glasses

(71) Applicant: Mercedes-Benz Group AG, Stuttgart (DE)

(72) Inventors: Kavita Saney, Fremont, CA (US); Kevin Gee, Union City, CA (US); Conner Ward, San Bruno, CA (US); Per-Anders Edwards, Santa Rosa, CA (US)

(21) Appl. No.: 18/492,992

(22) Filed: Oct. 24, 2023

(51) Int. Cl. G06T 11/00; B60R 25/102; B60R 25/104; B60R 25/24; G06F 3/01; G06F 3/03

(52) U.S. Cl. CPC G06T 11/00; B60R 25/102; B60R 25/104; B60R 25/245; G06F 3/011; G06F 3/03; G06T 2200/24

(57) ABSTRACT

Methods, computing systems, and technology for authorizing vehicle actions. For example, a computing system may be configured to receive sensor data indicative of a first user within a threshold distance of a vehicle. The computing system may be configured to determine, based on the sensor data, an intent of the first user to access the vehicle. The computing system may be configured to, based on the intent, output one or more signals to initiate a display of content for a second user via a user interface of a wearable display device, the content comprising the sensor data and an access request. The computing system may be configured to receive a response to the access request, wherein the response is indicative of an authorization decision for a vehicle action. The computing system may be configured to control, based on the authorization decision, a component of the vehicle.

### FIELD

The present disclosure relates generally to using machine-learned models to remotely authorizing vehicle actions. More particularly, the present disclosure relates to leveraging an augmented reality user interface to present vehicle authorization requests to a vehicle owner based on an in-vehicle machine-learned model determining the intent of a user to access or operate the vehicle.

### BACKGROUND

Programmatic remote access controls may be unreliable and inflexible. Predetermined remote access criteria may provide overly stringent or insufficient controls to authorize access to a vehicle. For instance, remotely unlocking a vehicle without verifying the user intending to access the vehicle may result in unauthorized access or operation of the vehicle.

### SUMMARY

Aspects and advantages of implementations of the present disclosure will be set forth in part in the following description, or may be learned from the description, or may be learned through practice of the implementations.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIGS. 2A-D illustrate diagrams of an example computing architecture for an onboard computing system of a vehicle according to an embodiment hereof.

FIG. 3 illustrates an example vehicle interior with an example display according to an embodiment hereof.

FIG. 4 illustrates a diagram of an example computing platform that is remote from a vehicle according to an embodiment hereof.

FIG. 5 illustrates a diagram of an example user device according to an embodiment hereof.

FIG. 6 illustrates an example vehicle operation according to an embodiment hereof.

FIG. 7 illustrates an example tactile sensor according to an embodiment hereof.

FIG. 8 illustrates an example authorization request according to embodiments hereof.

FIG. 9 illustrates an example key according to an embodiment hereof.

FIG. 10 illustrates an example dataflow pipeline according to an embodiment hereof.

FIG. 11 illustrates a flowchart diagram of an example method according to an embodiment hereof.

FIG. 12 illustrates a diagram of an example computing ecosystem with computing components according to an embodiment hereof.

### DETAILED DESCRIPTION

An aspect of the present disclosure relates to systems and methods for remotely authorizing vehicle access or operations. For instance, a vehicle owner may be remote from their vehicle and intend to authorize a user to access or operate the vehicle. The vehicle owner may want to limit the level of access or the ability of the user to operate the vehicle. For example, the vehicle owner may only intend to authorize user access to the vehicle interior or operate the vehicle for a limited duration. Remotely unlocking or starting the vehicle may result in unauthorized access and operation if the authorized user is not near the vehicle while it is in an unlocked state or running state. Additionally, providing the vehicle owner's key to the user may inconvenience the vehicle owner and result in the user having unfettered access to operate the vehicle in a manner which exceeds the anticipated use by the vehicle owner.

To address this problem, the technology of the present disclosure allows the vehicle owner to utilize a head-worn user device (e.g., augmented reality (AR) glasses) and a smart key to remotely authorize vehicle access and operations. For example, the vehicle owner may be remote from the vehicle and a user may express an intent to access or operate the vehicle. Expressing an intent to access or operate the vehicle may include approaching the vehicle, touching the vehicle, or a combination thereof. For example, the vehicle may utilize one or more machine-learned user intent models to determine the user's intent to access or operate the vehicle. For instance, the vehicle may include one or more sensors to detect users within a threshold distance of the vehicle. Once the sensors detect a user within a threshold distance from the vehicle, the sensors may capture sensor data identifying the user and determining an intent of the user to access or operate the vehicle. Sensor data may include image data, video data, or any other visual data.

The vehicle may include one or more tactile sensors configured to obtain tactile data. Tactile data may include haptic feedback or other data which captures the sense of touch. For instance, a user may approach the vehicle and touch a door handle, trunk, or other portion of the vehicle to indicate the users' intent to access or operate the vehicle. The user intent model may receive the tactile data and determine, based on tactile data, an intent of the user to access or operate the vehicle. In some examples, the user intent model may determine, based on sensor data and tactile data, the intent of the user to access or operate the vehicle.

The technology of the present disclosure may improve the energy usage and onboard computing technology of the vehicle. For instance, the vehicle may determine the intent of the user to access or operate the vehicle and transmit an authorization request (e.g., one or more signals) to the vehicle owner. By way of example, the vehicle's onboard computing system (e.g., vehicle computing system) may transmit via one or more networks, to a head-worn user device (e.g., AR glasses), a signal indicating the user is intending to access or operate the vehicle. The head-worn user device may display an image or video of the user intending to access or operate the vehicle and an authorization request. The authorization request may prompt the vehicle owner to authorize or reject a request allowing the user to access or operate the vehicle. Once the vehicle owner authorizes or rejects the request, the head-worn user device may transmit an authorization response to the vehicle indicating whether to allow the user to access or operate the vehicle. Accordingly, the vehicle leverage the computing resources of other devices to avoid spending its own energy or computing resources to authenticate and authorize users intending to access or operate the vehicle. This may allow the vehicle to reduce the usage of the vehicle's batteries by reducing the load on the vehicle's onboard computing memory, processing, and communication resources. This allows the vehicle to drive longer and operate its core functions in a more energy-efficient manner.

In some examples, the vehicle owner and the user may be remote from the vehicle and the vehicle owner may provide the user with a magnetic key which provides a predetermined authorization to access or operate the vehicle. For instance, the vehicle owner may configure, via the head-worn user device, a magnetic key associated with the head-worn user device based on one or more predetermined access profiles. Predetermined access profiles may authorize vehicle functions based on a user possessing the magnetic key within a threshold distance from the vehicle. Example, predetermined access profiles may include vehicle access profiles authorizing access to the vehicle interior or storage unit, timed vehicle operation privileges, etc. In this way, the vehicle computing system can more efficiently utilize its computing resources, as well as reduce energy otherwise expended authenticating users intending to access or operate the vehicle.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

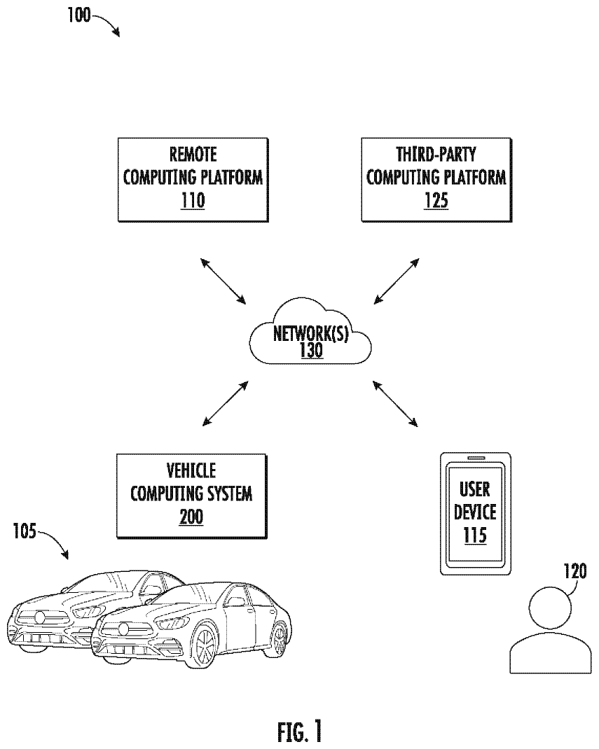

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 120. The user 120 may be the owner of the vehicle. In some implementations, the user 120 may be a user intending to operate the vehicle. In some implementations, the computing ecosystem 100 may include a third party (3P) computing platform 125, as further described herein. The vehicle 105 may include a vehicle computing system 200 located onboard the vehicle 105. The computing platform 110, the user device 115, the third party computing platform 125, and/or the vehicle computing system 200 may be configured to communicate with one another via one or more networks 130.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may be associated with (e.g., operated by) an entity. For example, the remote computing platform 110 may be associated with an OEM that is responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a computing system of the vehicle 105 (e.g., vehicle computing system 200) or the user device 115. The computing platform 110 may include one or more inter-service APIs for communication among its microservices. In some implementations, the computing platform may include one or more RPCs for communication with the user device 115.

The computing platform 110 may include one or more computing devices. For instance, the computing platform 110 may include a control circuit and a non-transitory computer-readable medium (e.g., memory). The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone (e.g., voice commands), a camera or other imaging device, a motion sensor (e.g., physical commands), etc. The user device 115 may include one or more output components such as a display device (e.g., display screen), a speaker, etc. For a wearable device such as a pair of smart-glasses, the display device may be formed/integrated into the lens of the glasses or the display device may have a form-figure in the shape of the lens.

In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the vehicle computing system 200, computing platform 110, etc.

The third-party computing platform 125 may include a computing system that is remote from the vehicle 105, remote computing platform 110, and user device 115. In an embodiment, the third-party computing platform 125 may include a cloud-based server system. The term “third-party entity” may be used to refer to an entity that is different than the entity associated with the remote computing platform 110. For example, as described herein, the remote computing platform 110 may be associated with an OEM that is responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that is available to or downloaded on the vehicle computing system 200.

The third-party computing platform 125 may include one or more back-end services provided by a third-party entity. The third-party computing platform 125 may provide services that are accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), or other types of services. The third-party computing platform 125 may host or otherwise include one or more APIs for communicating data to/from the third-party computing system 125 to other systems/devices of the ecosystem 100.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

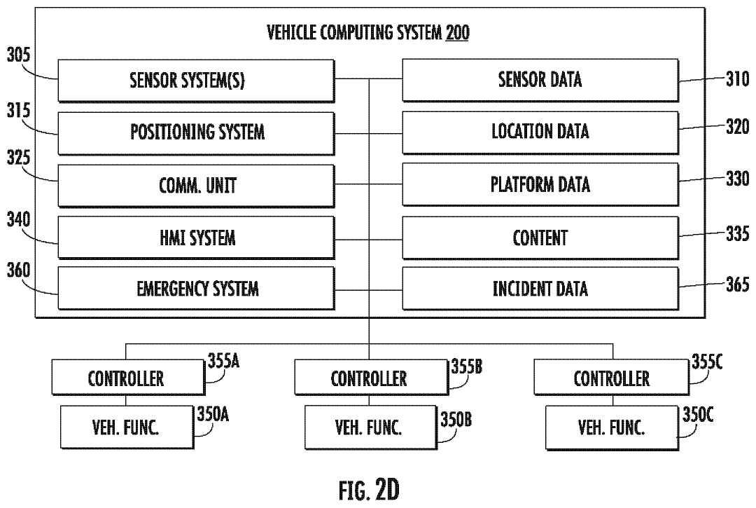

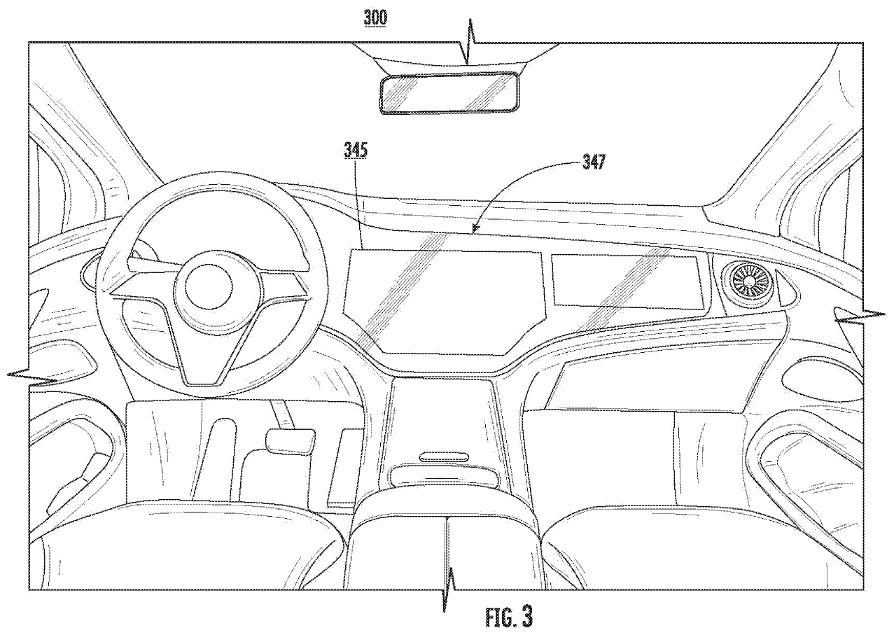

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle 105 may include a display device such as a display screen associated with an infotainment system, as further described with respect to FIG. 3.

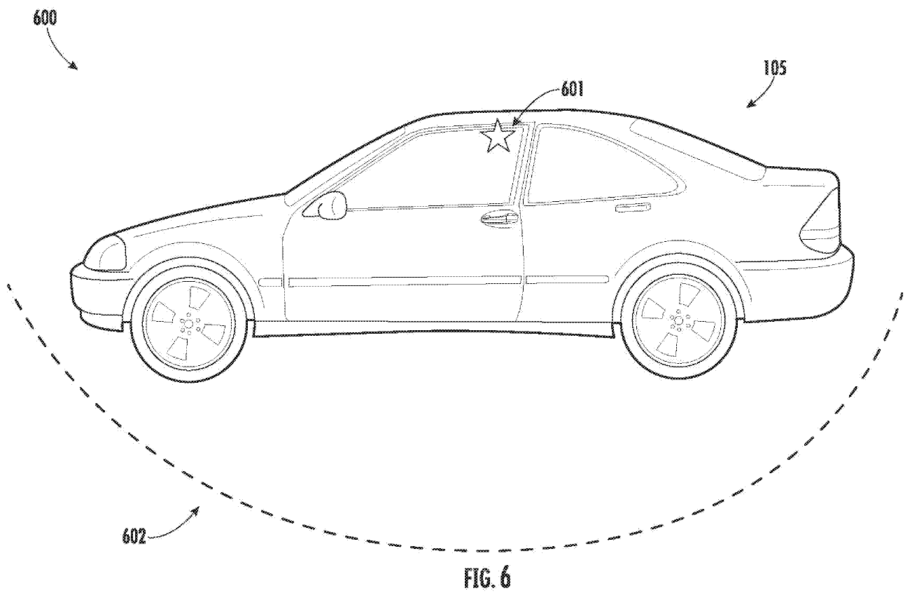

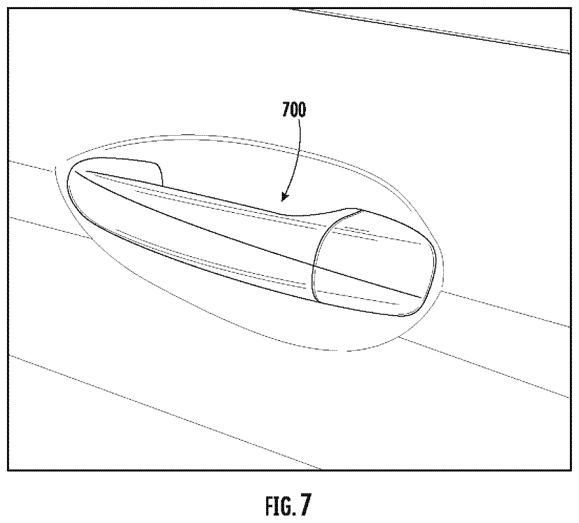

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc. The vehicle 105 may include one or more sensors for detecting movement within a threshold distance from the vehicle 105. For instance, the vehicle 105 may include one or more camera sensors to detect a user 120 within a threshold distance from the vehicle 105. An example of a camera sensor detecting movement within a threshold distance from the vehicle is further described with reference to FIG. 6. The vehicle 105 may include one or more tactile sensors for detecting a user 120 touching a portion of the vehicle. An example of a tactile sensor is further described with respect to FIG. 7.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system, may act as an external buffer or repository for storing information. In such an example, the computing system may retrieve or otherwise receive the information from the non-transitory computer-readable medium 140.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 is onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105.

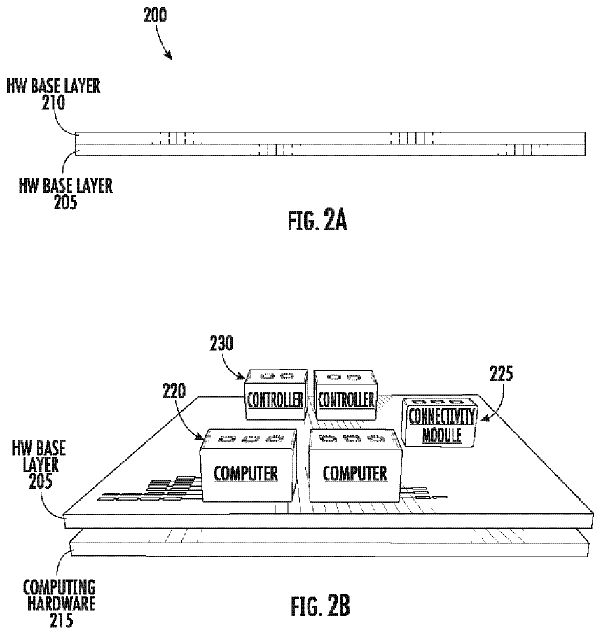

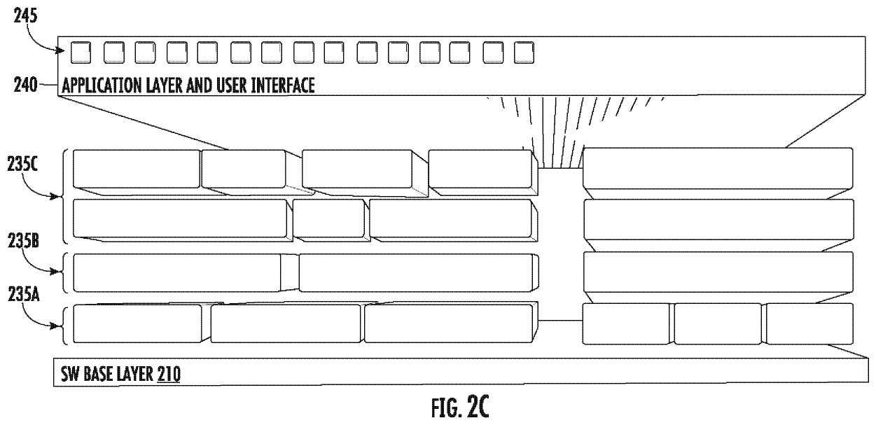

FIG. 2A illustrates an overview of an operating system of the vehicle computing system 105. The operating system may be a layered operating system. The vehicle computing system 200 may include a hardware layer 205 and a software layer 210. The hardware and software layers 205, 210 may include sub-layers. In some implementations, the operating system of the vehicle computing system 200 may include other layers (e.g., above, below, or in between those shown in FIG. 2A). In an example, the hardware layer 205 and the software layer 210 can be standardized base layers of the vehicle's operating system.

FIG. 2B illustrates a diagram of the hardware layer 205 of the vehicle computing system 200. In the layered operating system of the vehicle computing system 200, the hardware layer 205 can reside between the physical computing hardware 215 onboard the vehicle 105 and the software (e.g., of software layer 210) that runs onboard the vehicle 105.

The hardware layer 205 may be an abstraction layer including computing code that allows for communication between the software and the computing hardware 215 in the vehicle computing system 200. For example, the hardware layer 205 may include interfaces and calls that allow the vehicle computing system 200 to generate a hardware-dependent instruction to the computing hardware 215 (e.g., processors, memories, etc.) of the vehicle 105.

The hardware layer 205 may be configured to help coordinate the hardware resources. The architecture of the hardware layer 205 may be serviced oriented. The services may help provide the computing capabilities of the vehicle computing system 105. For instance, the hardware layer 205 may include the domain computers 220 of the vehicle 105, which may host various functionality of the vehicle 105 such as the vehicle's intelligent functionality. The specification of each domain computer may be tailored to the functions and the performance requirements where the services are abstracted to the domain computers. By way of example, this permits certain processing resources (e.g., graphical processing units) to support the functionality of a central in-vehicle infotainment computer for rendering graphics across one or more display devices for navigation, games, etc. or to support an intelligent automated driving computer to achieve certain industry assurances.

The hardware layer 205 may be configured to include a connectivity module 225 for the vehicle computing system 200. The connectivity module may include code/instructions for interfacing with the communications hardware of the vehicle 105. This can include, for example, interfacing with a communications controller, receiver, transceiver, transmitter, port, conductors, or other hardware for communicating data/information. The connectivity module 225 may allow the vehicle computing system 200 to communicate with other computing systems that are remote from the vehicle 105 including, for example, remote computing platform 110 (e.g., an OEM cloud platform).

The architecture design of the hardware layer 205 may be configured for interfacing with the computing hardware 215 for one or more vehicle control units 230. The vehicle control units 230 may be configured for controlling various functions of the vehicle 105. This may include, for example, a central exterior and interior controller (CEIC), a charging controller, or other controllers as further described herein.

The software layer 205 may be configured to provide software operations for executing various types of functionality and applications of the vehicle 105. FIG. 2C illustrates a diagram of the software layer 210 of the vehicle computing system 200. The architecture of the software layer 210 may be service oriented and may be configured to provide software for various functions of the vehicle computing system 200. To do so, the software layer 210 may include a plurality of sublayers 235A-E. For instance, the software layer 210 may include a first sublayer 235A including firmware (e.g., audio firmware) and a hypervisor, a second sublayer 235B including operating system components (e.g., open-source components), and a third sublayer 235C including middleware (e.g., for flexible integration with applications developed by an associated entity or third-party entity).

The vehicle computing system 200 may include an application layer 240. The application layer 240 may allow for integration with one or more software applications 245 that are downloadable or otherwise accessible by the vehicle 105. The application layer 240 may be configured, for example, using containerized applications developed by a variety of different entities.

The layered operating system and the vehicle's onboard computing resources may allow the vehicle computing system 200 to collect and communicate data as well as operate the systems implemented onboard the vehicle 105. FIG. 2D illustrates a block diagram of example systems and data of the vehicle 105.

The vehicle 105 may include one or more sensor systems 305. A sensor system 305 may include or otherwise be in communication with a sensor of the vehicle 105 and a module for processing sensor data 310 associated with the sensor configured to acquire the sensor data 305. This may include sensor data 310 associated with the surrounding environment of the vehicle 105, sensor data associated with the interior of the vehicle 105, or sensor data associated with a particular vehicle function. The sensor data 310 may be indicative of conditions observed in the interior of the vehicle, exterior of the vehicle, or in the surrounding environment. For instance, sensors of the vehicle 105 may include exterior sensors for detecting motion within a threshold distance of the vehicle or detecting when a portion of the vehicle 105 has been touched. Sensor data 310 may include image data, data indicative of a position of a user/object within a threshold distance of the vehicle 105, motion/gesture data, audio data, tactile data, or other types of data. The sensors may include one or more: cameras (e.g., visible spectrum cameras, infrared cameras), motion sensors, tactile sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors.

The vehicle 105 may include a positioning system 315. The positioning system 315 may be configured to generate location data 320 (also referred to as position data) indicative of a location (also referred to as a position) of the vehicle 105. For example, the positioning system 315 may determine location by using one or more of inertial sensors (e.g., inertial measurement units, etc.), a satellite positioning system, based on IP address, by using triangulation and/or proximity to network access points or other network components (e.g., cellular towers, WiFi access points, etc.), or other suitable techniques. The positioning system 315 may determine a current location of the vehicle 105. The location may be expressed as a set of coordinates (e.g., latitude, longitude), an address, a semantic location (e.g., “at work”), etc.

In an embodiment, the positioning system 315 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), parking restrictions, or other traffic signals or control devices/markings (e.g., cross walks)); or any other data. The positioning system 315 may localize the vehicle 105 within the environment (e.g., across multiple axes) based on the map data. For example, the positioning system 155 may process certain sensor data 310 (e.g., LIDAR data, camera data, etc.) to match it to a map of the surrounding environment to get an understanding of the vehicle's position within that environment. The determined position of the vehicle 105 may be used by various systems of the vehicle computing system 200 or another computing system (e.g., the remote computing platform 110, the third-party computing platform 125, the user device 115).

The vehicle 105 may include a communications unit 325 configured to allow the vehicle 105 (and its vehicle computing system 200) to communicate with other computing devices. The vehicle computing system 200 may use the communications unit 325 to communicate with the user device 115 or one or more other remote computing devices over a network 130 (e.g., via one or more wireless signal connections). For example, the vehicle computing system 200 may utilize the communications unit 325 to receive authorization responses from the user device 115. This may include, for example, one or more authorized vehicle actions executable by the vehicle computing system 200. Additionally, or alternatively, the vehicle computing system 200 may utilize the communications unit 325 to send vehicle data 335 (e.g., authorization requests) to the user device 115. The vehicle data 335 may include any data acquired onboard the vehicle 105 including, for example, sensor data 310, location data 320, user input data, or other types of data obtained (e.g., acquired, accessed, generated, downloaded, etc.) by the vehicle computing system 200.

In some implementations, the communications unit 325 may allow communication among one or more of the systems on-board the vehicle 105.

In an embodiment, the communications unit 325 may utilize various communication technologies such as, for example, Bluetooth low energy protocol, radio frequency signaling, or other short range or near filed communication technologies. The communications unit 325 may include any suitable components for interfacing with one or more networks, including, for example, transmitters, receivers, ports, controllers, antennas, or other suitable components that may help facilitate communication.

The vehicle 105 may include one or more human-machine interfaces (HMIs) 340. The human-machine interfaces 340 may include a display device, as described herein. The display device (e.g., touchscreen) may be viewable by a user of the vehicle 105 (e.g., user 120) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats). The human-machine interfaces 340 may present content via a user interface for display to a user 120.

FIG. 3 illustrates an example vehicle interior 300 with a display device 345. The display device 345 may be a component of the vehicle's infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like. The display device 345 may be located on, form a portion of, or function as a dashboard of the vehicle 105. The display device 345 may include a display screen, CRT, LCD, plasma screen, touch screen, TV, projector, tablet, and/or other suitable display components.

The display device 345 may display a variety of content to the user 120 including information about the vehicle 105, prompts for user input, etc. The display device 345 may include a touchscreen through which the user 120 may provide user input to a user interface.

For example, the display device 345 may include user interface rendered via a touch screen that presents various content. The content may include vehicle speed, mileage, fuel level, charge range, navigation/routing information, audio selections, streaming content (e.g., video/image content), internet search results, comfort settings (e.g., temperature, humidity, seat position, seat massage), or other vehicle data 335. The display device 345 may render content to facilitate the receipt of user input. For instance, the user interface of the display device 345 may present one or more soft buttons with which a user 120 can interact to adjust various vehicle functions (e.g., navigation, audio/streaming content selection, temperature, seat position, seat massage, etc.). Additionally, or alternatively, the display device 345 may be associated with an audio input device (e.g., microphone) for receiving audio input from the user 120.

Returning to FIG. 2D, the vehicle 105 may include an emergency system 360. The emergency system 360 may be configured to obtain incident data 365. The incident data 365 may be indicative of an incident event including the vehicle 105. For example, the incident data 365 may include sensor data 310 from one or more sensors such as an airbag sensor, an impact sensor configured to detect an impact to the vehicle 105 by another object, a sensor configured to detect damaged vehicle components, a sensor configured to detect broken wired or wireless connections, etc. The incident event may include an accident, collision with an object (e.g., other vehicle, tree, guard rail), an unsafe vehicle maneuver (e.g., rollover, swerve offroad), etc. In some implementations, the emergency system 360 may be included in the communications system 325.

The vehicle 105 may include a plurality of vehicle functions 350A-C. A vehicle function 350A-C may be a functionality that the vehicle 105 is configured to perform based on a detected input. The vehicle functions 350A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions. The user 120 may interact with a vehicle function 250A-C through user input (e.g., to an adjustable input device, UI element) that specifies a setting of the vehicle function 250A-C selected by the user.

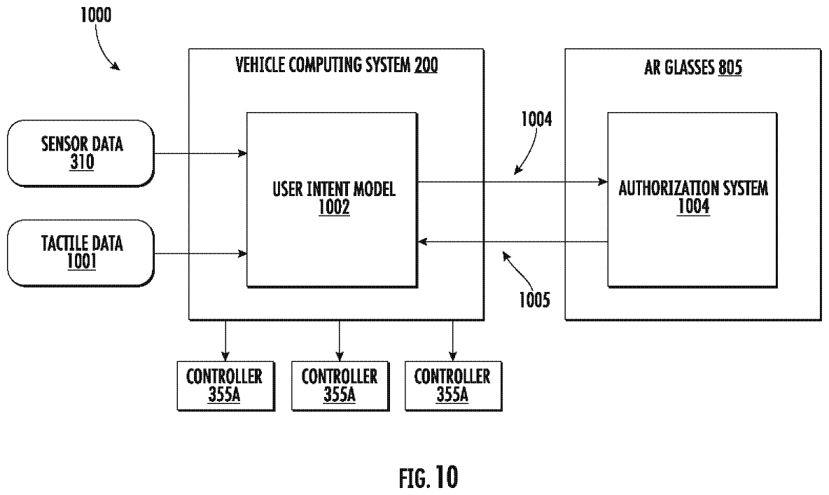

In an embodiment, the vehicle functions 350A-C may be a functionality that the vehicle 105 is authorized to perform based on the vehicle owner remotely authorizing the vehicle function 350A-C. For instance, the vehicle owner may be remote from the vehicle 105 and authorize one or more vehicle functions 350A-C to be performed for a user 120 intending to access or operate the vehicle 105. An example of a vehicle owner remotely authorizing vehicle functions 350A-C is further described with reference to FIG. 10.

Each vehicle function may include a controller 355A-C associated with that particular vehicle function 350A-C. The controller 355A-C for a particular vehicle function may include control circuitry configured to operate its associated vehicle function 350A-C. For example, a controller may include circuitry configured to unlock a door, turn on the ignition, turn the seat heating function on, to turn the seat heating function off, set a particular temperature or temperature level, etc.

In an embodiment, a controller 355A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 355A-C may be configured to send signals to another onboard system. The signals may encode data associated with a respective vehicle function. The encoded data may indicate, for example, a function setting, timing, etc. In an example, such data may be used to generate content for presentation via the display device 345 (e.g., showing a current setting). In another examples, such data may be used to generate AR content for presentation via the user device 115 (e.g., AR glasses). Additionally, or alternatively, such data can be included in vehicle data 335 and transmitted to the remote computing platform 110.

FIG. 4 illustrates a diagram of computing platform 110, which is remote from a vehicle according to an embodiment hereof. As described herein, the computing platform 110 may include a cloud-based computing platform.

In some implementations, the computing platform 110 may be implemented on a server, combination of servers, or a distributed set of computing devices which communicate over a network. For instance, the computing platform 110 may be distributed using one or more physical servers, private servers, or cloud computing. In some examples, the computing platform 110 may be implemented as a part of or in connection with one or more microservices, where, for example, an application is architected into independent services that communicate over APIs. Microservices may be deployed in a container (e.g., standalone software package for a software application) using a container service, or on VMs (virtual machines) within a shared network. Example, microservices may include a microservice associated with the vehicle software system 405, remote assistance system 415, etc. A container service may be a cloud service that allows developers to upload, organize, run, scale, manage, and stop containers using container-based virtualization to orchestrate their respective actions. A VM may include virtual computing resources which are not limited to a physical computing device. In some examples, the computing platform 110 may include or access one or more data stores for storing data associated with the one or more microservices. For instance, data stores may include distributed data stores, fully managed relational, NoSQL, and in-memory databases, etc.

The computing platform 110 may include a remote assistance system 415. The remote assistance system 415 may provide assistance to the vehicle 105. This can include providing information to the vehicle 105 to assist with charging (e.g., charging locations recommendations), remotely controlling the vehicle 105 (e.g., for AV assistance), remotely accessing the vehicle 105 (e.g., remote authorizations), roadside assistance (e.g., for collisions, flat tires), etc. The remote assistance system 415 may obtain assistance data 420 to provide its core functions. The assistance data 420 may include information that may be helpful for the remote assistance system 415 to assist the vehicle 105. This may include information related to the vehicle's current state, an occupant's current state, the vehicle's location, the vehicle's route, charge/fuel level, incident data, etc. In some implementations, the assistance data 420 may include the vehicle data 335.

The remote assistance system 415 may transmit data or command signals to provide assistance to the vehicle 105. This may include providing data indicative of relevant charging locations, remote control commands to move the vehicle, remote authorization approvals, etc.

The computing platform 110 may include a security system 425. The security system 425 can be associated with one or more security-related functions for accessing the computing platform 110 or the vehicle 105. For instance, the security system 425 can process security data 430 for identifying digital keys, magnetic keys, authorization requests, data encryption, data decryption, etc. for accessing the services/systems of the computing platform 110. Additionally, or alternatively, the security system 425 can store security data 430 associated with the vehicle 105. A user 120 can request authorization to access or operate the vehicle 105 (e.g., by approaching the vehicle 105, touching the vehicle, voice commands, etc.). In the event the user 120 has a magnetic key for the vehicle 105 as indicated in the security data 430, the security system 425 can provide a signal to perform one or more vehicle functions 350A-C based on a the predetermined authorization profile associated with the magnetic key.

The computing platform 110 may include a navigation system 435 that provides a back-end routing and navigation service for the vehicle 105. The navigation system 435 may provide map data 440 to the vehicle 105. The map data 440 may be utilized by the positioning system 315 of the vehicle 105 to determine a location of the vehicle 105, a point of interest, etc. The navigation system 435 may also provide routes to destinations requested by the vehicle 105 (e.g., via user input to the vehicle's head unit). The routes can be provided as a portion of the map data 440 or as separate routing data. Data provided by the navigation system 435 can be presented as content on the display device 345 of the vehicle 105.

The computing platform 110 may include an entertainment system 445. The entertainment system 445 may access one or more databases for entertainment data 450 for a user 120 of the vehicle 105. In some implementations, the entertainment system 445 may access entertainment data 450 from another computing system associated with a third-party service provider of entertainment content. The entertainment data 450 may include media content such as music, videos, gaming data, etc. The entertainment data 450 may be provided to vehicle 105, which may output the entertainment data 450 as content via one or more output devices of the vehicle 105 (e.g., display device, speaker, etc.).

The computing platform 110 may include a user system 455. The user system 455 may create, store, manage, or access user profile data 460. The user profile data 460 may include a plurality of user profiles, each associated with a respective user 120. A user profile may indicate various information about a respective user 120 including the user's preferences (e.g., for music, comfort settings, parking preferences), frequented/past destinations, past routes, etc. The user profiles may be stored in a secure database. In some implementations, when a user 120 enters the vehicle 105, the user's key (or user device 115) may provide a signal with a user or key identifier to the vehicle 105. The vehicle 105 may transmit data indicative of the identifier (e.g., via its communications system 325) to the computing platform 110. The computing platform 110 may look-up the user profile of the user 120 based on the identifier and transmit user profile data 460 to the vehicle computing system 200 of the vehicle 105. The vehicle computing system 200 may utilize the user profile data 460 to implement preferences of the user 120, present past destination locations, etc. The user profile data 460 may be updated based on information periodically provided by the vehicle 105. In some implementations, the user profile data 460 may be provided to the user device 120.

In an embodiment, the vehicle owner may be remote from the vehicle 105 and provide a magnetic key associated with the user device 115 (e.g., AR glasses) to the user 120. When the user 120 approaches the vehicle 150, the magnetic key associated with the vehicle owner may provide a signal or key identifier to the vehicle 105. The magnetic key may be associated with one or more predetermined authorization profiles which authorizes the user 120 to access or operate the vehicle 105. The vehicle 105 may transmit data indicative of the identifier (e.g., via its communications system 325) to the computing platform 110. The computing platform 110 may look-up the predetermine authorization profiles based on the identifier and transmit the predetermined authorization profile (e.g., user profile data 460) associated with the magnetic key to the vehicle computing system 200 of the vehicle 105.

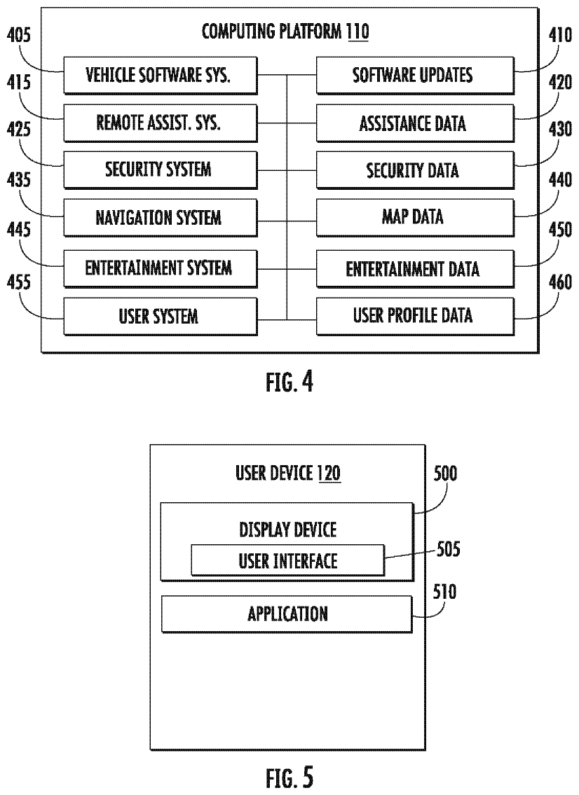

FIG. 5 illustrates a diagram of example components of user device 115 according to an embodiment hereof. The user device 115 may include a display device 500 configured to render content via a user interface 505 for presentation to a user 120. The display device 500 may include a display screen, AR glasses lens, CRT, LCD, plasma screen, touch screen, TV, projector, tablet, or other suitable display components. The user device 115 may include a software application 510 that is downloaded and runs on the user device 115. In some implementations, the software application 510 may be associated with the vehicle 105 or an entity associated with the vehicle 105 (e.g., manufacturer, retailer, maintenance provider). In an example, the software application 510 may enable the user device 115 to communicate with the computing platform 110 and the services thereof.

The user device 115 may be configured to pair with the vehicle 105 via a short-range wireless protocol. The short-range wireless protocol may include, for example, at least one of Bluetooth®, Wi-Fi, ZigBee, UWB, IR. The user device 115 may pair with the vehicle 105 through one or more known pairing techniques. For example, the user device 115 and the vehicle 105 may exchange information (e.g., IP addresses, device names, profiles) and store such information in their respective memories. Pairing may include an authentication process whereby the user 120 validates the connection between the user device 115 and the vehicle 105. In some examples, the user device 115 may be configured to pair with the vehicle 105 over one or more networks 130 such as the internet. For instance, the user device 115 may be remote from the vehicle 105 and pair with the vehicle 105 over a network 130.

Once paired, the vehicle 105 and the user device 115 may exchange signals, data, etc. through the established communication channel. For example, the head unit 347 of the vehicle 105 may exchange signals with the user device 115.

The technology of the present disclosure allows the vehicle computing system 200 to extend its computing capabilities by leveraging the computing resources of the user device 115. More particularly, the vehicle computing system 200 may leverage the user device 115 to present authorization requests for users 120 intending to access or operate the vehicle 105. Examples described herein reference a vehicle owner as a party that may provide access to a user 120. This is meant for example purposes only and is not meant to be limiting. Other parties associated with the vehicle 105 may be presented with requests and provide access. This can include a party that is leasing/renting the vehicle, a security entity, a dealership, a support service of the vehicle manufacturer, etc. As described herein, this technology can overcome potential inefficiencies introduced by authorizing access or vehicle operations of vehicle 105 using inflexible authentication criteria.

FIG. 6 illustrates an example vehicle operation according to an embodiment hereof. The example vehicle operation 600 depicts a vehicle 105 in a parked or stationary state. In an embodiment, the vehicle 105 may utilize one or more exterior sensors 601 to detect motion within a threshold distance 602 from the vehicle 105. The vehicle 105 may detect that a user 120 is intending to access or operate the vehicle 105 based on the exterior sensor 601 detecting the user 120 within the threshold distance 602 from the vehicle 105.

The exterior sensor 601 may be one or more cameras (e.g., visible spectrum cameras, infrared cameras), motion sensors, audio sensors (e.g., microphones), temperature sensors, humidity sensors, Light Detection and Ranging (LIDAR) systems, Radio Detection and Ranging (RADAR) systems, or any type of sensor capable of detecting proximity to the vehicle 105. The exterior sensor 601 may include a single sensor (e.g., camera sensor) or a plurality of sensors (e.g., camera sensor, motion sensor, audio sensor, etc.). While the example exterior sensor 601 is depicted on the pillar (e.g., vertical structure between the front and read doors) of the vehicle 105, the exterior sensor 601 is not limited to such embodiment. The exterior sensor 601 may be located on any portion of the vehicle 105. For instance, the exterior sensor 601 may be located on the roof, wheels, front windshield, back window, or other exterior surfaces of the vehicle 105. In some examples, the exterior sensor 601 may be encapsulated within the vehicle 105 such that the exterior sensor 601 may detect motion outside the vehicle 105 within the threshold distance 602. In an embodiment the exterior sensor 601 may include a tactile sensor. An example of a tactile sensor is further described with reference to FIG. 7.

The vehicle 105 may be in an off or parked state and utilize the exterior sensors 601 to detect users 120 within the threshold distance 602. For example, the vehicle 105 may be parked in a parking lot or garage. In an embodiment, the vehicle 105 may utilize battery resources to power the exterior sensors 601. For instance, the exterior sensors 601 may passively detect motion or activity in the surrounding environment of the vehicle 105. Passively detecting motion may include capturing ephemeral sensor data of the surrounding environment of the vehicle 105 for the purposes of detecting the proximity of the motion.

The exterior sensors 601 may detect motion within the threshold distance 602 from the vehicle 105. The threshold distance 602 may include a radius distance around the vehicle 105. For instance, the threshold distance 602 may include a 3 foot radius, 2 foot radius, or 1 foot radius around the vehicle 105. In some examples, the threshold distance 602 may include varying distances from the vehicle 105. For instance, the threshold distance 602 from the driver door may include a 2 foot distance, while the threshold distance 602 from the passenger door may include a 3 foot distance.

In some examples, the vehicle 105 may configure the threshold distance 602 based on the location of the vehicle 105. For instance, the vehicle 105 (e.g., vehicle computing system 200) may determine, based on map data 440, that the vehicle 105 is located in a busy parking lot. The vehicle computing system 200 may configure the threshold distance 602 to 1 foot or less to preserve computing resources. For instance, a busy parking lot may include substantial motion within a 3 or 4 foot threshold distance 602 unrelated to a user 120 intending to access the vehicle 105. Configuring the threshold distance 602 to include a lower distance may better calibrate the threshold distance 602 to avoid actively capturing sensor data for motion unrelated to the vehicle 105. In an embodiment the vehicle owner may configure the threshold distance 602 via the display device 345, head unit 347, etc.

The exterior sensors 601 may detect motion within the threshold distance 602 and begin actively capturing sensor data. For instance, the exterior sensors 601 may capture sensor data to be processed by one or more machine-learned models running within the vehicle computing system 200. The machine-learned models may process the sensor data to identify users 120 and determine an intent of the user 120 to access or operate the vehicle 105. An example of machine-learned models processing sensor data to identify a user 120 and determine an intent of the user 120 is further described with reference to FIG. 10.

FIG. 7 illustrates an example tactile sensor according to an embodiment hereof. The example tactile sensor 700 may be any device that measures forces in response to physical interaction (e.g., touching) with the environment. For instance, the tactile sensor 700 may be able to detect contact, pressure, force, or temperature. While the example tactile sensor 700 is depicted on the door handle of the vehicle 105, the tactile sensor is not limited to this embodiment. The tactile sensor 700 may be positioned on any portion of the vehicle exterior such as the trunk, door panel, roof, etc.

The tactile sensor 700 may be used to determine or confirm an intent of a user 120 to access or operate the vehicle 105. By way of example, the exterior sensors 601 may detect motion within the threshold distance 602 from the vehicle and begin capturing sensor data to identify the user 120. The user 120 may additionally touch a tactile sensor 700 (e.g., touch the door handle of the vehicle 105) and the tactile sensor 700 may capture tactile data. The tactile data may be used by one or more machine-learned models running within the vehicle computing system 200 to determine the intent of the user 120 to access or operate the vehicle 105. An example of tactile data being used to determine the intent of the user 120 to access or operate the vehicle 105 if further described with reference to FIG. 10.

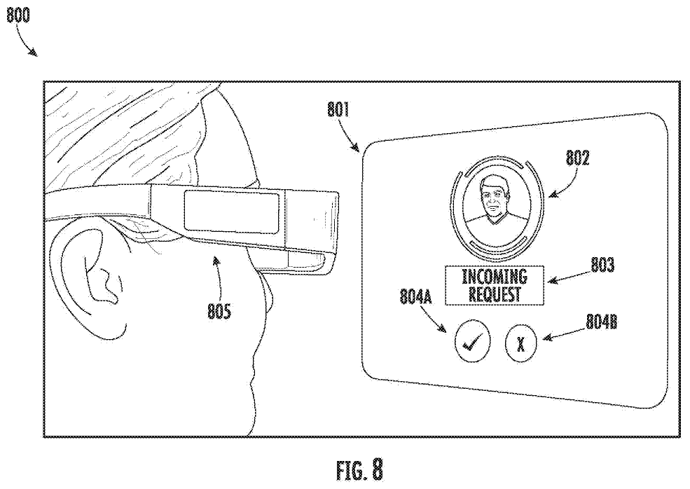

The vehicle 105 (e.g., vehicle computing system 200) may utilize exterior sensors 601 and tactile sensors 700 to obtain sensor data and tactile data indicative of a user 120 within the threshold distance 602 from the vehicle 105. The vehicle 105 (e.g., vehicle computing system 200) may obtain the sensor data and tactile data, determine the user 120 is intending to access or operate the vehicle 105, and transmit signals to the user device 115 (e.g., AR glasses). For instance, the user device 115 may display the user 120 and an authorization request to the vehicle owner. The authorization request may prompt the vehicle owner with authorization and rejection options indicating an authorization decision for the user 120 to access or operate the vehicle 105. An example of the user device 115 displaying the user 120 and an authorization request is further described with reference to FIG. 8.

FIG. 8 illustrates an example authorization request according to embodiments hereof. The example authorization request 800 depicts augmented reality (AR) glasses 805 displaying AR content 801 based on signals received from the vehicle computing system 200. The AR content 801 may include a requestor interface element 802 indicating the user 120 intending to access or operate the vehicle 105, the request interface element 803 indicating the status and type of authorization request, an authorize interface element 804A, and a reject interface element 804B to respond to the authorization request. In an embodiment, the vehicle owner may be associated with the AR glasses 805 and interact with the AR content 801 rendered via the AR glasses 805. For instance, vehicle owner may interact with the interface elements (e.g., request interface element 803, authorize interface element 804A, reject interface element 804B, etc.) to review, authorize, reject, or modify the authorization request 800.

The AR glasses 805 may be a head-worn user device (e.g., user device 115). For instance, the AR glasses 805 may include a computing device owned or otherwise accessible to the vehicle owner. For instance, the AR glasses 805 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the AR glasses 805 may include one or more input components such as buttons, a touch screen, a joystick or other cursor control, a stylus, a microphone (e.g., voice commands), a camera or other imaging device, a motion sensor (e.g., physical commands), etc. The AR glasses 805 may include one or more output components such as a display device (e.g., display screen), a speaker, etc. For instance, the AR glasses 805 may include a display device formed/integrated into the lens of the AR glasses 805 in the shape of the lens.

In an embodiment, the AR glasses 805 may receive content generated from the vehicle computing system 200 and display the content via the AR glasses 805. In some examples, the display of the AR glasses may include the field of view of the vehicle owner associated with the AR glasses 805 (e.g., wearing the AR glasses 805). By way of example, the AR glasses 805 may include a lens which augments the field of view of the vehicle owner wearing the AR glasses 805. The vehicle computing system 200 may be connected to the AR glasses over one or more networks 130 or via near field or short range communication techniques. The vehicle computing system 200 may generate AR content 801 indicative of the user 120 intending to access or operate the vehicle 105, an authorization request (e.g., request interface 803), and options to authorize or reject (e.g., authorize interface element 804A, reject interface element 804B) the authorization request.

By way of example, one or more exterior sensors 601 may detect a user 120 within a threshold distance 602 from the vehicle 105. Machine-learned models running within the vehicle computing system 200 may determine an intent of the user 120 to access or operate the vehicle 105 and the vehicle computing system 200 may transmit data (e.g., signals) indicating the user 120 and an authorization request to the AR glasses 805. The AR glasses 805 may receive the signals and initiate a display of the AR content 801 via the AR glasses 805.

The AR content 801 may include sensor data 310 indicating an image or video stream of the user 120. For instance, the sensor data 310 captured by the exterior sensors 601 and utilized by the vehicle computing system 200 to identify the user 120 may be transmitted to the AR glasses 805 such that the vehicle owner may identify the identity of the user 120 attempting to access or operate the vehicle 105. In an embodiment, the requestor interface element 802 may include an image or video stream of the user 120 rendered by the AR glasses 805. For instance, a video stream may include a requestor interface 802 which allows for a video call communication with the user 120. The vehicle owner may confirm the identity of the user 120 and, based on the request interface element 803 indicating the scope of the authorization request, decide whether to approve or reject the request.

In an embodiment, the vehicle owner may interact with the AR content 801 displayed via the AR glasses 805 using voice commands or physical gestures. For instance, the vehicle owner may speak a voice command (e.g., verbal command) to respond to the authorization request 800. Example voice commands may include “Hey Mercedes®” commands or any other verbal commands. For example, the vehicle owner may interact with a Mercedes® virtual assistant running on the vehicle 105 via the AR glasses 805 by speaking the wake words “Hey Mercedes®”. Wake words may cause the AR glasses 805 to record the voice (e.g., voice commands) of the vehicle owner and encode the commands as instructions (e.g., authorization instructions, rejection instructions, etc.). The voice command (e.g., encoded instructions) may be transmitted to the Mercedes® virtual assistant (e.g., vehicle 105). In some examples, the vehicle owner may perform physical gestures (e.g., hand movements, head movements, eye blinking, touching the AR glasses 805, etc.) to interact with the AR content 801. For instance, the vehicle owner may use a hand gesture (e.g., pointing, touching, etc.) to select the authorize interface element 804A or reject interface element 804B to indicate an authorization decision.

The AR glasses 805 may render a display of the AR content 801 indicating the user 120 (e.g., requestor interface element 802) and the request interface element 803. The request interface element 803 may include data indicating the scope or type of authorization requested for the user 120. For instance, the request interface element 803 may indicate that the user 120 is requesting access to the trunk of the vehicle 105. The vehicle owner may verify the identity of the user 120 and decide to approve the authorization request. In an example, approving the authorization request (e.g., verbally or physically selecting the authorize interface element 804A) may only authorize the vehicle computing system 200 to unlock the trunk of the vehicle 105 for the user 120.

In an embodiment, the vehicle owner may decide to reject the authorization request. For instance, the request interface element 803 may indicate an unfamiliar or unexpected user 120 is attempting to operate the vehicle 105. For example, the requestor interface element 802 may depict a stranger and the request interface element 803 may indicate the stranger is attempting to access the vehicle interior through the driver door. The vehicle owner may reject the authorization request to prevent the stranger from accessing the vehicle 105. Rejecting the authorization request (e.g., verbally or physically selecting the reject interface element 804B) may prohibit the vehicle computing system 200 from unlocking the driver door, locking the driver door, or any other vehicle actions which prevent/deter the user 120 from accessing or operating the vehicle 105. Additionally, or alternatively, rejecting the authorization request may result in the security system 425 performing one or more operations (e.g., alarm, locking doors, etc.) to secure the vehicle 105.

In an embodiment, the vehicle owner may modify the scope of the authorization request to limit or expand authorized vehicle actions. For instance, the request interface element 803 may be an interactable user interface element. By way of example, the vehicle owner may interact (e.g., verbal commands, physical commands, etc.) with the request interface element 830 via hand gestures, voice commands, gaze, etc. The vehicle owner may select a different authorization action or profile to consider. For instance, the vehicle computing system 200 may store a plurality of authorization profiles associated with a set of authorized vehicle actions. An example authorization profile may include a valet parking authorization profile. The valet parking authorization profile may authorize the user 120 (e.g., valet attendant) to operate the vehicle 105 within a defined geographic area such as a parking garage. For instance, the valet parking authorization profile may prevent the user 120 (e.g., valet attendant) from exceeding a speed threshold or prevent the vehicle 105 from being started (e.g., ignition on) once the vehicle 105 has reached a parked state.

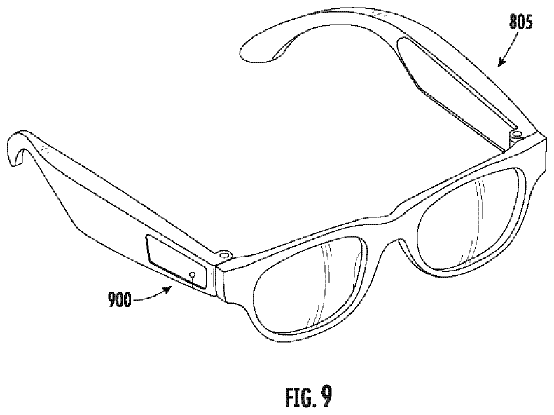

Example authorization profiles may include granular vehicle actions such as access only where a user 120 may only open one or more doors of the vehicle 105, timed vehicle operation where the user 120 may operate the vehicle 105 for a specified time before additional authorization is required, or any other vehicle actions. The vehicle owner may modify the authorization request via the request interface element 803 and authorize the vehicle 105 to perform one or more vehicle functions within the scope of the authorization approval. In some examples, the vehicle owner may pre-configure one or more authorization profiles. For instance, the vehicle owner may select via the display device, head unit 347, etc. one or more authorization profiles indicating pre-determined vehicle actions which may be authorized concurrently. In an embodiment, an authorization profile may be assigned to a magnetic key associated with the AR glasses 805. An example of an authorization profile assigned to a magnetic key is further described with reference to FIG. 9.

FIG. 9 illustrates an example magnetic key according to an embodiment hereof. The example magnetic key 900 may be affixed to a portion or a surface of the AR glasses 805. For instance, the magnetic key 900 may be affixed using one or more magnets within the magnetic key 900 and the AR glasses 805. In some examples, the magnetic key 900 may be affixed using other attachment methods such as a clasping mechanism which secures the outermost boundaries of the magnetic key 900. The magnetic key 900 may be affixed to the AR glasses using any mechanism which allows for retrieval and storage of the magnetic key 900.

The vehicle owner may configure the magnetic key 900 to authorize one or more vehicle actions. For instance, the vehicle owner (e.g., wearer of the AR glasses 805) may interact with one or more software applications running on the AR glasses 805 to assign an authorization profile to the magnetic key 900. For example, the AR glasses 805 may execute one or more instructions to run an instance of a software application. The launch of a software application may initiate a user-network session with the vehicle computing system 200, computing platform 110, etc., and present user interfaces which allow the vehicle owner to select, modify, or remove authorized vehicle actions. For instance, the vehicle 105 may detect the magnetic key 900 within the threshold distance 602 and allow the user 120 to perform one or more pre-authorized vehicle actions selected by the vehicle owner.

By way of example, the vehicle owner and user 120 may both be remote from the vehicle 105. The vehicle owner may configure the magnetic key 900 to authorize the user 120 to unlock the trunk of the vehicle 105 to retrieve one or more items. In an embodiment, the configuration file may be stored in the remote platform 110 accessible to the vehicle computing system 200. For instance, the magnetic key configuration may be stored with user profile data 460 (e.g., associated with the vehicle owner's user profile). The vehicle owner may provide the magnetic key 900 to the user 120 and the user 120 may navigate to the vehicle 105 and unlock the trunk of the vehicle 105 to retrieve the one or more items. In an embodiment, the configured magnetic key 900 may prevent the user 120 from performing vehicle actions which have not been configured (e.g., authorized). For instance, a magnetic key 900 configured to authorize trunk access may prevent the user 120 from unlocking or accessing the vehicle interior, starting the vehicle 105, etc. As such the magnetic key 900 may allow the vehicle owner to provide granular authorizations without consuming computing resources of the vehicle 105.

FIG. 10 illustrates an example dataflow pipeline according to an embodiment hereof. The following description of dataflow in data pipeline 1000 is described with an example implementation in which the vehicle computing system 200 utilizes a user intent model 1002 to process sensor data 310 and tactile data 1001 to facilitate authorization requests with an AR glasses 805. The vehicle computing system 200 may receive an authorization response 1005 and the vehicle computing system 200 may utilize one or more controllers 355A-C to implement vehicle actions authorized by the authorization response 1005.

The vehicle computing system 200 may include one or more machine-learned models that utilize sensor data 310 and/or tactile data 1001 to generate output 1004 indicative of the user 120 intending to access operate the vehicle 105 and an authorization request. For instance, the vehicle computing system 200 may include a user intent model 1002. Sensor data 310 may include image data, video data, or any other data which may be used to visualize the surrounding environment. Tactile data 1001 may include haptic feedback or other data which captures the sense of touch. For instance, the user 120 may approach the vehicle and touch a door handle, trunk, or other portion of the vehicle 105.

In an embodiment, the user intent model 1002 may be an unsupervised or supervised learning model configured to detect users 120 within the threshold distance from the vehicle and determine an intent of the user 120 to access or operate the vehicle 105. In some examples, the user intent model 1002 may include one or more machine-learned models. For example, the user intent model 1002 may include a machine-learned model trained to detect users 120 within the threshold distance. In some examples, the user intent model 1002 may include a machine-learned model trained to determine an intent of the user 120. In other examples, the user intent model 1002 may include a machine-learned model trained to distinguish users 120 from other objects (e.g., cars, animals, etc.) in motion within the threshold distance, by executing segmentation techniques.

The user intent model 1002 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The user intent model 1002 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating users 120, intent expressions, etc. In some examples, the training data may include simulated training data (e.g., training data obtained from simulated scenarios, inputs, configurations, various parking areas, etc.).

Additionally, or alternatively, the model trainer(s) may perform unsupervised training techniques using unlabeled training data. By way of example, the model trainer(s) may train one or more components of a machine-learned model to perform user detection and intent detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The user intent model 1002 may obtain sensor data 310 indicative of a user 120 within the threshold distance or tactile data 1001 indicative of an intent of the user 120. In an embodiment, the user intent model 1002 may be trained to detect users 120 by performing segmentation techniques. Segmentation techniques may include analyzing the sensor data 310 including one or more image frames and projecting a bounding shape on the image frames.

The bounding shape may be any shape (e.g., polygon) that includes one or more users 120. For instance, a bounding shape may include a shape that matches the outermost boundaries and contours of those boundaries for a user 120. One of ordinary skill in the art will understand that other shapes may be used such as squares, circles, rectangles, etc. In some implementations, the bounding shape may be generated on a per pixel level. The space characteristics may include the x, y, z coordinates of the bounding shape center, the length, width, and height of the bounding shape, etc.

The user intent model 1002 may generate data (e.g., labels) that correspond to the user characteristics of the bounding shape. Labels may indicate the user 120, intent characteristics of the user 120 such as the direction of motion (e.g., direction label), velocity (e.g., velocity label), eye movements (e.g., focus label), position/orientation of user 120 relative to the vehicle 105 (e.g., position label), etc.

The user intent model 1002 may detect one or more users 120 within the threshold distance 602 based on sensor data 310 captured by the exterior sensors 601. For instance, the user intent model 1002 may receive sensor data 310 indicating a user 120 near the vehicle 105 (e.g., within the threshold distance 602). The threshold distance 602 may include a 3 foot radius, 2 foot radius, or 1 foot radius, etc. around the vehicle 105. In an embodiment, the threshold distance 602 may include smaller radius measurements such as 12 inches or less from the exterior sensors 601. The user intent model 1002 may analyze the sensor data 310 and determine, based on labels, an intent of the user 120 to access or operate the vehicle 105.

By way of example, the user intent model 1002 may receive sensor data including an image frame of a user 120. The user intent model 1002 may analyze the image frame and generate labels indicating intent characteristics of the user 120. For instance, the user intent model 1002 may determine that the user 120 is walking towards the vehicle 105 and is making eye contact with the vehicle 105. The user intent model 1002 may generate a direction label indicating the user 120 is moving in a direction towards the vehicle and a focus label indicating the user 120 has a focus on the vehicle 105. The user intent model 1002 may determine based the direction label and focus label an intent of the user 120. For instance, the user intent model 1002 may determine a high probability of the user 120 possessing an intent to access or operate the vehicle 105 based on the user 120 being within the threshold distance, the direction label, and the focus label. In some examples, the user intent model 1002 may determine intent characteristics (e.g., labels) exceeds a threshold to determine an intent of the user 120. In other examples, the user intent model 1002 may receive additional input to determine the intent of the user 120.

For instance, the user intent model 1002 may determine an intent of the user 120 based on tactile data 1001. For example, the exterior sensor 601 may fail to capture clear or usable sensor data 310 and a user 120 may touch the vehicle 105 (e.g., grab the tactile sensor 700). The user intent model 1002 may determine, based on the user 120 within the threshold distance 602 and tactile data 1001 the intent of the user 120 to access or operate the vehicle.

In an embodiment, the user intent model 1002 may utilize both sensor data 310 and tactile data 1001 to determine the intent of the user 120 to access or operate the vehicle 105. For example, the exterior sensor 601 may detect a user 120 within the threshold distance 602 and obtain sensor data 310 identifying the user 120. In an embodiment, the sensor data 310 may be insufficient to determine the intent of the user 120 to access or operate the vehicle 105. For instance, the user 120 may stop moving near the vehicle 105, focus on an object of interest other than the vehicle 105, or otherwise vacillate accessing or operating the vehicle 105. In some examples, the user intent model 1002 may require additional input to determine an intent of the user 120. In an embodiment, the user 120 may touch the vehicle 105. For example, the tactile sensor 700 may capture tactile data 1001 indicating the user 120 touching a portion of the vehicle 105. The tactile data 1001 may indicate the user 120 grabbed a door handle, engaged a trunk latch of the vehicle 105, etc. The user intent model 1002 may determine the intent of the user 120 based on the sensor data 310 detecting and identifying the user 120 and the tactile data indicating the user 120 attempting to access the vehicle 105.

The user intent model 1002 may determine the intent of the user 120 to access or operate may the vehicle 105 and generate output 1004 data associated with an authorization request. For instance, the output 1004 may be indicative of an intent of the user 120. In an embodiment, the output 1004 may be used by the vehicle computing system 200 to generate an authorization request (e.g., one or more signals transmitted to the AR glasses 805) to authorize the user 120 to access or operate the vehicle 105. In some examples, the output 1004 may be indicative of the intent of the user 120 and an authorization request. For instance, the output 1004 may include the intent of the user 120 and an authorization request. In other examples, the output 1004 may include a portion of the sensor data 310 (e.g., image or video stream of the user 120).

In an embodiment, the output 1004 indicating intent of the user 120 to access or operate the vehicle 105 may be processed and used to generate one or more signals to be transmitted to the AR glasses 805. For instance, the vehicle computing system 200 may convert the output 1004 into one or more signals (e.g., indicating an authorization request) to generate AR content 801. For example, the vehicle computing system 200 may, based on the output 1004, generate an authorization request and transmit signals over one or more networks (e.g., network 130) or via near field communication techniques to the AR glasses 805. In some examples, the signals may include the output 1004 and an authorization request. In some examples, the user intent model 1002 may directly output 1004 signals indicating the intent of the user and the authorization request to the AR glasses 805. In other examples, the signals may include sensor data 310 and/or tactile data 1001.

In an embodiment, the AR glasses 805 may utilize the signals and/or the output 1004 to generate AR content 801. AR content 801 may include computer generated content integrated into the real world. For instance, the AR glasses 805 may create digital content which may be displayed on the AR glasses 805 (e.g., user device 115). By way of example, the AR glasses 805 may receive one or more signals and/or output 1004 indicating the user 120 is intending to access the vehicle 105 while positioned at the passenger door of the vehicle 105. The AR glasses 805, based on the one or more signals and/or output 1004, may generate AR content 801 including the requestor interface element 802 indicating the user 120 is intending to access the vehicle 105, the request interface element 803 indicating the status and type of authorization request, an authorize interface element 804A, and a reject interface element 804B to respond to the authorization request.

The vehicle owner (e.g., wearer of the AR glasses 805) may interact with one or more interface elements to authorize or reject the authorization request. For instance, the vehicle owner may perform verbal or physical commands to generate an authorization response 1005 to respond to the authorization request. In an embodiment, the AR glasses 805 may transmit the authorization response 1005 over one or more networks (e.g., network 130) or via near field communication techniques to the vehicle computing system 200. For instance, the vehicle computing system 200 may determine, based on the authorization response 1005, that one or more vehicle actions has been authorized or rejected. The vehicle computing system 200 may utilize one or more vehicle controllers 355A to perform one or more vehicle functions 350A-C within the scope of the authorization response 1005. For instance, the vehicle computing system 200 may utilize the vehicle controllers 355A-C to unlock the driver door and remotely start the vehicle 105. In some examples, other systems such as the remote computing platform 110, third-party computing platform 125, etc. may receive the authorization response 1005 and determine one or more vehicle actions.

In some examples, the vehicle computing system 200 may authorize the vehicle controllers 355A to allow vehicle functions 350A-C to be manually executed. For instance, the vehicle controller 355A which controls the door lock vehicle function 350A may allow the door to be unlocked when engaged by the user 120. In another example, the vehicle controller 355B which controls the ignition vehicle function 350B may allow the vehicle 105 to start (e.g., ignition on state) when the user engages the ignition switch. The vehicle computing system 200 may authorize the vehicle controllers 355A-C to perform or allow vehicle functions 350A-C within the scope of the authorization response 1005.

In an embodiment, the AR glasses may transmit the authorization response 1005 over one or more networks (e.g., network 130) or via near field communication techniques to the user intent model 1002. In an embodiment, the user intent model 1002 may receive the authorization response 1005 and determine one or more vehicle actions to be taken by the vehicle 105. In some examples, the authorization response may be used to further train the user intent model 1002. For instance, the user intent model 1002 may receive the authorization response 1005 and determine the accuracy of the user intent prediction. For example, the user intent model 1002 may be further trained based on receiving an authorization response 1005 which validates the user intent prediction. In some examples, one or more parameters of the user intent model 1002 may be updated based on the authorization response. By way of example, the authorization response 1005 may indicate that the vehicle owner rejected the authorization request due to the user 120 not having an intent to access or operate the vehicle 105. The user intent model 1002 may receive the authorization response 1005 and update one or more parameters based on the incorrect prediction of intent of the user 120.

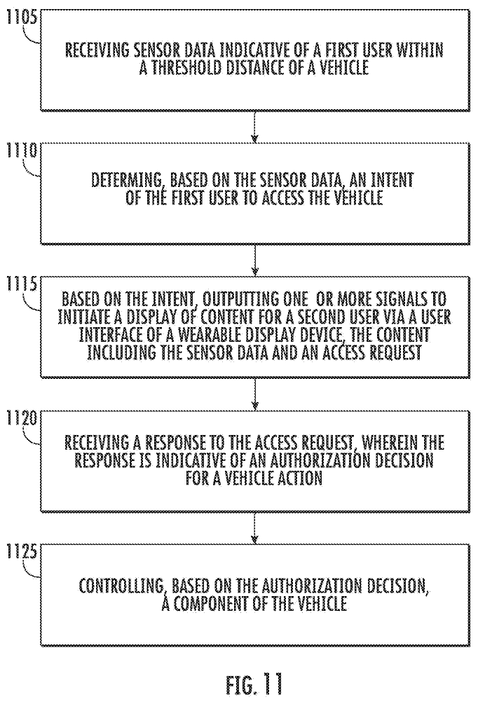

FIG. 11 illustrates a flowchart diagram of an example method 1100 for remotely authorizing a user according to an embodiment hereof. The method 1100 may be performed by a computing system described with reference to the other figures. In an embodiment, the method 1100 may be performed by the control circuit of a vehicle computing system 200 of FIG. 1. One or more portions of the method 1100 may be implemented as an algorithm on the hardware components of the devices described herein. For example, the steps of method 1100 may be implemented as operations/instructions that are executable by computing hardware.

FIG. 11 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 11 is described with reference to elements/terms described with respect to other systems and figures, for example illustrated purposes and is not meant to be limiting. One or more portions of method 1100 may be performed additionally, or alternatively, by other systems. For example, method 1100 may be performed by a control circuit of the user device 115 or the AR glasses 805.

In an embodiment, the method 1100 may begin with or otherwise include an operation 1105: receiving sensor data indicative of a first user within a threshold distance of a vehicle. For instance, the user intent model 1002 within the vehicle computing system 200 may receive (e.g., directly or indirectly via an intermediate system) sensor data 310 from one or more exteriors sensors 601 within a threshold distance 602 from the vehicle 105. The exterior sensors 601 may passively capture ephemeral sensor data 310 and actively capture sensor data 310 when motion within the threshold distance 602 is detected.

The method 1100 in an embodiment may include an operation 1110: determining, based on the sensor data, an intent of the first user to access the vehicle. For instance, the user intent model 1002 may analyze the sensor data 310 and generate one or more labels to determine an intent of the user 120 to access or operate the vehicle 105. By way of the example, the user intent model 1002 may analyze one or more image frames included in the sensor data 310 and generate labels. For instance, the user intent model 1002 may generate a focus label indicating the eyes of the user 120 are focused on a portion of the vehicle such as the door handle or trunk. The user intent model 1002 may generate additional labels such as direction labels, orientation labels, positioning labels etc.

The user intent model 1002 may determine based on the labels the intent of the user 120 to access or operate the vehicle 105. For instance, the user intent model may determine one or more intent labels exceeds a threshold and determine an intent of the user 120. In some examples, the user intent model 1002 may determine, based on a single label the intent of the user 120. For instance, the user intent model 1002 may determine, based on the distance label indicting the user 120 is inches away from the vehicle door handle, a high probability of the intent of the user 120 to access or operate the vehicle 105. In other examples, tactile data 1001 may be used alone or in combination with sensor data 310 to determine the intent of the user 120.

The method 1100 in an embodiment may include an operation 1115: based on the intent, outputting one or more signals to initiate a display of content for a second user via a user interface of a wearable display device, the content including the sensor data and an access request. For instance, the user intent model 1002 may output 1004 data indicative of intent of the user 120 to access the vehicle 105. In an embodiment, the output 1004 may be used by the vehicle computing system 200 to generate an authorization request (e.g., one or more signals) which generate AR content 801 to be displayed on AR glasses 805. In an embodiment, the user intent model 1002 may directly generate an authorization request (e.g., one or more signals) to generate AR content 801 to be displayed on AR glasses 805.

For example, the vehicle computing system 200 may determine, based on the output 1004, the intent of the user 120 to access or operate the vehicle. In some examples, the vehicle computing system 200 may generate an authorization request which may include a portion of the sensor data 310 (e.g., image or video stream of the user 120). For instance, the authorization request may include an image or video of the user 120. In some examples, the user intent model 1002 may determine the intent of the user 120 and generate an authorization request (e.g., one or more signals). For instance, the user intent model 1002 may generate an authorization request which includes a portion of the sensor data 310.

In some examples, the authorization request may be transmitted over one or more networks (e.g., network 130) or via near field communication techniques to the AR glasses 805. For example, the AR glasses 805 may process the authorization request and generate AR content 801. AR content 801 may include computer generated content integrated into the real world. For instance, the AR glasses 805 may receive the authorization request and create digital content which may be displayed on the AR glasses 805 (e.g., user device 115). By way of example, the AR glasses 805 may receive an authorization request including sensor data 310 (e.g., image of the user 120) and output 1004 indicating the user 120 as intending to access the vehicle 105 positioned at the passenger door of the vehicle 105. The AR glasses 805, based on the authorization request and/or output 1004, may generate AR content 801 including the requestor interface element 802 indicating the user 120 as intending to access the vehicle 105, the request interface element 803 indicating the status and type of authorization request, an authorize interface element 804A, and a reject interface element 804B to respond to the authorization request.

The method 1100 in an embodiment may include an operation 1120: receiving a response to the access request, wherein the response is indicative of an authorization decision for a vehicle action. For instance, the vehicle owner (e.g., wearer of the AR glasses 805) may interact with one or more interface elements to authorize or reject the authorization request. For instance, the vehicle owner may perform verbal or physical commands to generate an authorization response 1005 to respond to the authorization request. In an embodiment, the AR glasses 805 may transmit the authorization response 1005 over one or more networks (e.g., network 130) or via near field communication techniques to the vehicle computing system 200.

In an embodiment, the vehicle computing system 200 may receive the authorization response 1005 and determine one or more vehicle actions to be taken by the vehicle 105. By way of example, the authorization response 1005 may indicate that the user 120 is authorized to operate the vehicle 105. For instance, the authorization response 1005 may indicate the user 120 may access and operate the vehicle 105 for a specified duration. In some implementations, the user intent model 1002 may receive the authorization response 1005 and determine the vehicle action(s). For instance, the vehicle computing system 200 may determine one or more controllers 355A-C which may perform one or more vehicle functions 350A-C.

The method 1100 in an embodiment may include an operation 1125: controlling, based on the authorization decision, a component of the vehicle. For instance, the vehicle computing system 200 may utilize one or more controllers 355A-C to perform one or vehicle functions 350A-C within the scope of the authorization. For instance, the vehicle computing system 200 may utilize the vehicle controllers 355A-C to unlock the driver door and remotely start the vehicle 105. In some examples, the user 120 may engage a component of the vehicle 105 and the vehicle 105 may allow the action based on the authorization decision. For instance, the authorization response 1005 may allow the user 120 to access and operate the vehicle 105. The vehicle controllers 355A-C may allow the door to be unlocked when the door handle is engaged by the user 120 and allow the vehicle 105 to start when the ignition switch is engaged.

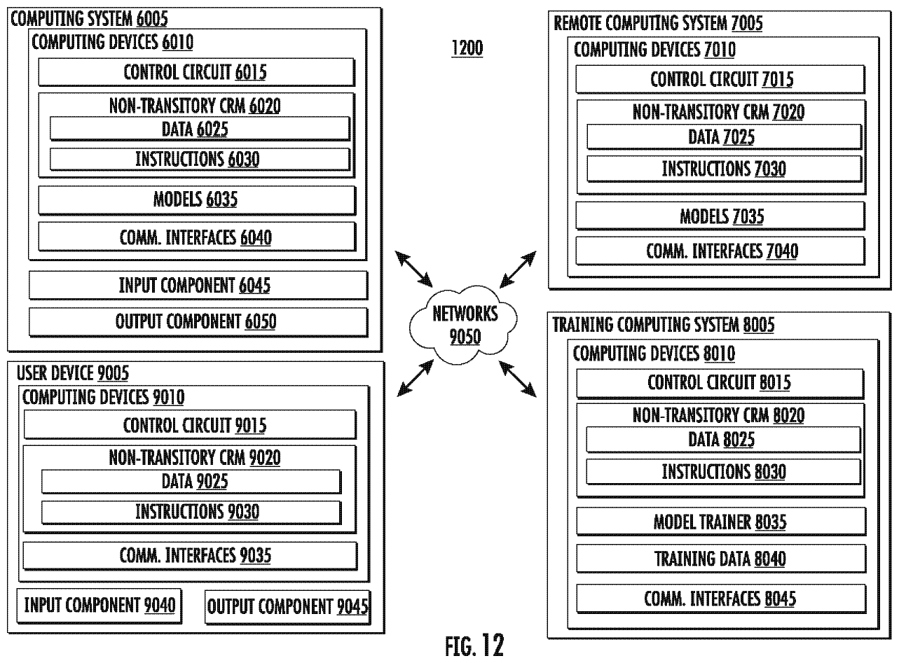

FIG. 12 illustrates a block diagram of an example computing system 1200 according to an embodiment hereof. The system 1200 includes a computing system 6005 (e.g., a computing system onboard a vehicle), a remote computing system 7005 (e.g., computing platform 110), a user device 9005 (e.g., an AR glasses 805), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the method of FIG. 11.

In an embodiment, the computing system 6005 may store or include one or more machine-learned models 6035. For example, the machine-learned models 6035 may be or may otherwise include various machine-learned models, including machine-learned generative models (e.g., the user intent model 1002). In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to identify and determine an intent of a user (e.g., user 120) to access or operate a vehicle (e.g., vehicle 105). For example, the machine-learned models 6035 can, in response to sensor data 1001A generate one or more labels indicating a user 120 and indicating intent characteristics of the user 120. The models 6035 may determine the intent of the user 120 to access or operate the vehicle 105.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include one or more computing devices 7010. In an embodiment, the remote computing system 7005 may include or is otherwise implemented by one or more computing devices onboard an autonomous drone. In instances in which the remote computing system 7005 includes computing devices within cloud infrastructure, such computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the method of FIG. 11.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 7050). In some implementations, the communication interfaces 7040 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIG. 11.

The training computing system 8005 may include a model trainer 8035 that trains the machine-learned models 6035, 7035 stored at the computing system 6005 and/or the remote computing system 7005 using various training or learning techniques. For example, the models 6035, 7035 (e.g., user intent model 1002) may be trained using a loss function that evaluates quality of generated samples over various characteristics, such as similarity to the training data.

The training computing system 8005 may modify parameters of the models 6035, 7035 (e.g., user intent model 1002) based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the user intent model 1002 to modify the parameters (e.g., weights) of the generative model (e.g., 620). The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. For example, the training data 8040 can be or can include the sensor data 1001A or tactile data 1001B of FIG. 10.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include various types of user devices. This may include head-worn wearable devices (e.g., AR glasses, watches, etc.), handheld devices, tablets, or other types of devices.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIG. 11.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input. In an embodiment, the input components 9040 may include audio and virtual components such as a microphone (e.g., voice commands), accelerometers/gyroscopes (e.g., physical commands), etc.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components. As described herein, the output components 9045 may include a form factor such as lens of glasses. This can be used for an AR interface displayed via the user device 9005, while it is worn by a user.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### Additional Discussion of Various Embodiments

Embodiment 1 relates to a computing system of a vehicle. The computing system may include a control circuit. The control circuit may be configured to receive sensor data indicative of a first user within a threshold distance of a vehicle. The control circuit may be configured to determine, based on the sensor data, an intent of the first user to access the vehicle. The control circuit may be configured to, based on the intent, output one or more signals to initiate a display of content for a second user via a user interface of a wearable display device, the content comprising the sensor data and an access request. The control circuit may be configured to receive a response to the access request, wherein the response is indicative of an authorization decision for a vehicle action. The control circuit may be configured to control, based on the authorization decision, a component of the vehicle.

Embodiment 2 includes the computing system of embodiment 1. In this embodiment, the control circuit may be configured to receive tactile data, the tactile data indicative of the intent of the first user to access the vehicle. The control circuit maybe configured to output the one or more signals to initiate the display of content based on the tactile data.

Embodiment 3 includes the computing system of embodiment 2. In this embodiment, the tactile data is indicative of the first user touching a surface of the vehicle.

Embodiment 4 includes the computing system of any of the embodiments 1 to 3. In this embodiment, the sensor data includes at least one of: (i) image data or (ii) video data.

Embodiment 5 includes the computing system of any of the embodiments 1 to 4. In this embodiment, the sensor data includes audio data, the audio data indicative of audio within a surrounding environment of the vehicle.

Embodiment 6 includes the computing system of embodiment 5. In this embodiment, to determine the intent of the first user to access the vehicle the control circuit may be configured to determine the intent of the first user to access the vehicle based on the audio data.

Embodiment 7 includes the computing system of any of the embodiments 1 to 6. In this embodiment, the control circuit is configured to detect a magnetic key associated with the first user within the threshold distance of the vehicle, the magnetic key associated with the wearable display device. The control circuit may be configured to determine, based on the magnetic key, the intent of the first user to access the vehicle.

Embodiment 8 includes the computing system of any of the embodiments 1 to 7. In this embodiment, the magnetic key is indicative of a pre-authorization decision, wherein the pre-authorization decision authorizes one or more vehicle actions.

Embodiment 9 includes the computing system of any of the embodiments 1 to 8. In this embodiment, the vehicle action includes at least one of providing access to the vehicle or starting the vehicle, and the control circuit is configured to control the component of the vehicle by performing at least one of unlocking a door of the vehicle or starting an ignition of the vehicle.

Embodiment 10 includes the computing system of any of the embodiments 1 to 9. In this embodiment, the authorization decision indicates an approval or a rejection of the access request.

Embodiment 11 relates to a computer-implemented method. The method can include receiving sensor data indicative of a first user within a threshold distance of a vehicle. The method can include determining, based on the sensor data, an intent of the first user to access the vehicle. The method can include, based on the intent, outputting one or more signals to initiate a display of content for a second user via a user interface of a wearable display device, the content comprising the sensor data and an access request. The method can include receiving a response to the access request, wherein the response is indicative of an authorization decision for a vehicle action. The method can include controlling, based on the authorization decision, a component of the vehicle.

Embodiment 12 includes the computer-implemented method of embodiment 11. In this embodiment, the method can include receiving tactile data, the tactile data indicative of the intent of the first user to access the vehicle. The method can include outputting the one or more signals to initiate the display of content based on the tactile data.

Embodiment 13 includes the computer-implemented method of embodiment 12. In this embodiment, the tactile data is indicative of the first user touching a surface of the vehicle.

Embodiment 14 includes the computer-implemented method of any of the embodiments 11 to 13. In this embodiment, the sensor data includes at least one of: (i) image data or (ii) video data.

Embodiment 15 includes the computer-implemented method of any of the embodiments 11 to 14. In this embodiment, the sensor data includes audio data, the audio data indicative of audio within a surrounding environment of the vehicle.

Embodiment 16 includes the computer-implemented method of embodiments 15. In this embodiment, determining the intent of the first user to access the vehicle includes determining the intent of the first user to access the vehicle based on the audio data.

Embodiment 17 includes the computer-implemented method of any of the embodiments 1 to 16. In this embodiment, the method can include detecting a magnetic key associated with the first user within the threshold distance of the vehicle, the magnetic key associated with the wearable display device. The method can include determining the intent of the first user to access the vehicle includes determining the intent of the first user to access the vehicle based on the magnetic key.

Embodiment 18 includes the computer-implemented method of embodiment 17. In this embodiment, the magnetic key is indicative of a pre-authorization decision, wherein the pre-authorization decision authorizes one or more vehicle actions.

Embodiment 19 includes the computer-implemented method of any of the embodiments 11 to 18. In this embodiment, controlling the component of the vehicle includes at least one of: (i) unlocking a door or (ii) starting an ignition.

Embodiment 20 is directed to one or more non-transitory computer-readable media. The one or more non-transitory computer readable media can store instructions that are executable by a control circuit. The control circuit executing the instructions can receive sensor data indicative of a first user within a threshold distance of a vehicle. The control circuit executing the instructions can determine, based on the sensor data, an intent of the first user to access the vehicle. The control circuit executing the instructions can, based on the intent, output one or more signals to initiate a display of content for a second user via a user interface of a wearable display device, the content including the sensor data and an access request. The control circuit executing the instructions can receive a response to the access request, wherein the response is indicative of an authorization decision for a vehicle action. The control circuit executing the instructions can control, based on the authorization decision, a component of the vehicle.

### ADDITIONAL DISCLOSURE

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

1. A computing system comprising:
a control circuit configured to:
receive image data indicative of a first user within a threshold distance of a vehicle;
detect, based on the image, one or more intent characteristics of the first user in the image data, the one or more intent characteristics indicative of a probability of intent of the first user;
receive, tactile data indicative of a portion of the vehicle contacted by the first user;
determine, based on the one or more intent characteristics in the image data and the tactile data, an intent of the first user to access the vehicle;
based on the intent, output one or more signals to initiate a display of content for a second user via a user interface of a wearable display device, the content comprising the image data and an access request;
receive a response to the access request, wherein the response is indicative of an authorization decision for a vehicle action; and
control, based on the authorization decision, a component of the vehicle.

2. The computing system of claim 1, wherein the control circuit is configured to:
output the one or more signals to initiate the display of content based on the tactile data.

3. The computing system of claim 2, wherein the tactile data indicates the first user manipulated a handle of the vehicle.

4. The computing system of claim 1, wherein the image data comprises video data.

5. The computing system of claim 1, wherein the control circuit is configured to receive audio data, the audio data indicative of audio within a surrounding environment of the vehicle.

6. The computing system of claim 5, wherein to determine the intent of the first user to access the vehicle the control circuit is configured to determine the intent of the first user to access the vehicle based on the audio data.

7. The computing system of claim 1, wherein the control circuit is configured to:
detect a magnetic key associated with the first user within the threshold distance of the vehicle, the magnetic key associated with the wearable display device; and
determine, based on the magnetic key, the intent of the first user to access the vehicle.

8. The computing system of claim 7, wherein the magnetic key is indicative of a pre-authorization decision, wherein the pre-authorization decision authorizes one or more vehicle actions.

9. The computing system of claim 1, wherein the vehicle action comprises at least one of providing access to the vehicle or starting the vehicle, and wherein the control circuit is configured to control the component of the vehicle by performing at least one of: unlocking a door of the vehicle or starting an ignition of the vehicle.

10. The computing system of claim 1, wherein the authorization decision indicates an approval or a rejection of the access request.

11. A computer-implemented method comprising:
receiving image data indicative of a first user within a threshold distance of a vehicle
detecting, based on the image data, one or more intent characteristics of the first user in the image data, the one or more intent characteristics indicative of a probability of intent of the first user;
receiving, tactile data indicative of a portion of the vehicle contacted by the first user;
determining, based on the one or more intent characteristics in the image data and the tactile data, an intent of the first user to access the vehicle;
based on the intent, outputting one or more signals to initiate a display of content for a second user via a user interface of a wearable display device, the content comprising the image data and an access request;
receiving a response to the access request, wherein the response is indicative of an authorization decision for a vehicle action; and
controlling, based on the authorization decision, a component of the vehicle.

12. The computer-implemented method of claim 11, further comprising:
outputting the one or more signals to initiate the display of content based on the tactile data.

13. The computer-implemented method of claim 12, wherein the tactile data indicates the first user manipulated a handle of the vehicle.

14. The computer-implemented method of claim 11, wherein the image data comprises video data.

15. The computer-implemented method of claim 11, further comprising receiving audio data, the audio data indicative of audio within a surrounding environment of the vehicle.

16. The computer-implemented method of claim 15, wherein determining the intent of the first user to access the vehicle comprises:
determining the intent of the first user to access the vehicle based on the audio data.

17. The computer-implemented method of claim 11, comprising:
detecting a magnetic key associated with the first user within the threshold distance of the vehicle, the magnetic key associated with the wearable display device; and
wherein determining the intent of the first user to access the vehicle comprises determining the intent of the first user to access the vehicle based on the magnetic key.

18. The computer-implemented method of claim 17, wherein the magnetic key is indicative of a pre-authorization decision, wherein the pre-authorization decision authorizes one or more vehicle actions.

19. The computer-implemented method of claim 11, wherein controlling the component of the vehicle comprises at least one of: (i) unlocking a door or (ii) starting an ignition.

20. One or more non-transitory computer-readable media storing instructions executable by a control circuit to:
receive image data indicative of a first user within a threshold distance of a vehicle;
detect, based on the image data, one or more intent characteristics of the first user in the image data, the one or more intent characteristics indicative of a probability of intent of the first user;
receive, tactile data indicative of a portion of the vehicle contacted by the first user;
determine, based on the one or more intent characteristics in the image data and the tactile data, an intent of the first user to access the vehicle;
based on the intent, output one or more signals to initiate a display of content for a second user via a user interface of a wearable display device, the content comprising the image data and an access request;
receive a response to the access request, wherein the response is indicative of an authorization decision for a vehicle action; and
control, based on the authorization decision, a component of the vehicle.
